(19) United States
(12) Patent Application Publication
(10) Pub. No.: US 2026/0342833 A1
(43) Pub. Date: Oct. 29, 2026

(54) Universal Framework for Simulating Compromised Applications to Test Computer Network Vulnerabilities

(71) Applicant: International Business Machines Corporation, Armonk, NY (US)

(72) Inventors: Teryl Paul TAYLOR, Colorado Springs, CO (US); Frederico ARAUJO, Mahopac, NY (US)

(73) Assignee: International Business Machines Corporation, Armonk, NY (US)

(21) Appl. No.: 18/771,240

(22) Filed: Jul. 12, 2024

(51) Int. Cl. H04L 9/40

(52) U.S. Cl. CPC H04L 63/1433; H04L 63/1408

(57) ABSTRACT

A framework is formed including an application server configured to initiate a probe sequence using a first target application. The framework is injected, including the application server, into the application space of the first target application. The first target application is programmed by the injected application server, including specifying the probe sequence and using the first target application as a vector to launch one or more simulated attacks on the computer network.

### GOVERNMENT RIGHTS

This invention was made with government support under W911NF-13-2-0045 awarded by Army Research Office(ARO). The government has certain rights to this invention.

### BACKGROUND

The present invention relates generally to security analysis, system-penetration/network-penetration and network infiltration systems aimed at enhancing network security. More particularly, the present invention relates to a method, system, and computer program designed for simulating compromised applications to test, investigate, discover, and mitigate computer network vulnerabilities.

One major challenge in conducting security analysis, assessments, system-penetration/network-penetration, and infiltration testing on systems is generating proof of exploits for each application that executes on a computer network. A proof of exploit demonstrates a proof-of-concept attack on an application, where the application is compromised and potentially used as a vector in a larger attack on the computer network. However, current systems are unable to compromise every application on the computer network. By inadequately exploring the security risks each application, if compromised, poses to the computer network, potential security gaps are left in the computer network. As result, the computer network may be vulnerable to future attacks or infiltration. This could lead to unauthorized access to sensitive data, disruption of services, and significant financial losses for the organization.

It would be desirable to have methods, systems, and computer programs designed for simulating compromised applications to test, investigate, discover, and mitigate computer network vulnerabilities that would overcome the above disadvantages.

### SUMMARY

The illustrative embodiments provide for a universal framework simulating compromised applications to test network vulnerabilities. An embodiment includes identifying a first target application. The embodiment also includes forming a framework including an application server configured to initiate a probe sequence using the first target application. The embodiment also includes injecting the framework including the application server into the application space of the first target application. The embodiment also includes programming the first target application by the injected application server, including specifying the probe sequence and to use the first target application as a vector to launch a plurality of simulated attacks on the computer network. The embodiment also includes launching the plurality of simulated attacks on the computer network using the first target application. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example red patching infrastructure in accordance with an illustrative embodiment;

FIG. 3 depicts a block diagram of an example storyboard synthesis and process instrumentation and execution architecture in accordance with an illustrative embodiment;

FIG. 4A depicts a block diagram of an example JIT patch synthesis and injection for an event-driven sequence in accordance with an illustrative embodiment;

FIG. 4B depicts a block diagram of an example JIT patch synthesis and injection in accordance with an illustrative embodiment; and

FIG. 5 depicts a flowchart of an example process for launching simulated adversary attacks on a computer network in accordance with an illustrative embodiment.

### DETAILED DESCRIPTION

The present disclosure addresses the deficiencies described above by providing a process (as well as a system, method, machine-readable medium, etc.) to launch simulated attacks from any application in the computer network. Providing improved functionality to launch simulated attacks from any application in the computer network matters for the following reasons. First, due to the varying sets of rights and privileges granted, each application on a computer network provides a distinct perspective and entry point to launch simulated attacks from and test the overall security of the computer network. Second, this improved functionality bridges the conceptual gaps that naturally exist between production-based and attack-emulation software. This is crucial for creating realistic attack scenarios and enabling learning-based approaches for intrusion detection that can be transferred to real computer networks for automated network security testing, Artificial Intelligence (AI) network security training, and red teaming and gaming exercises. Disclosed embodiments provide aforementioned advantages/benefits and technological improvements over the existing tools, techniques, and systems for simulating and detecting network infiltration and network-penetration.

An illustrative overview of an embodiment of the invention is as follows. red patching (e.g., red teaming), or the injection of an application server into a running (e.g., operable) and pre-existing target application, service or process on a computer on a computer network, generally comprises three stages: 1) Storyboard Synthesis, 2) Process Instrumentation, and 3) Function Hooking and Execution.

### Storyboard Synthesis Stage (i.e., Storyboarding)

At the first stage, an embodiment of the invention allows a user to plan the goals and objectives of a campaign to identify security gaps in specific computers on a computer network. A computer user interface (e.g., user interface (UI)) designs probe sequences using modules, configurations, computer code and snippets, sets of predefined tactics, techniques and procedures (TTPs), such as the ones defined in the Adversarial Tactics, Techniques, and Common Knowledge (MITRE ATT&CK) framework (i.e., a framework that provides a model and knowledge base for cyber adversary behavior), and probe/simulated attack kill chains (i.e., simulated attacks involving a combination of TTPs in a logical sequence). This stage further provides a comprehensive framework and rich toolset, supporting coding TTPs in various programming languages, such as JavaScript, and C/C++. Finally, the computer user interface of the first stage may generate modules, configurations, and probe code and then packages (e.g., form) them into a framework (including, but not limited to, a hooking agent, a storyboard package, an instrumentation plan, and a probe library) for deployment to the target application, as an application server. In some embodiments, the storyboard synthesis stage may be realized as at least one module, application, program or service and is delegated the responsibility for identifying one or more target applications and generating (i.e., forming) computer instructions or code (e.g., a framework) for the controlling or commandeering the one or more target applications for probing a computer network.

### Process Instrumentation Stage

At the second stage, a generated framework is received as output from the Storyboard Synthesis Stage. Before the simulations of attacks on the vulnerabilities of a computer network using the target application may be initiated, the generated framework may be injected (e.g., attached, or patched) into the control flow or application code of the target application. In some embodiments, the injection mechanism employed to inject the generated framework in the target application may be “Ptrace.” Ptrace enables one application or process to control the execution of another application, service, or process (i.e., target application) by deployment of a hooking agent. The hooking agent connects or latches to the running application, service, or process (i.e., target application), creates a thread of operation within the application space or control flow of the running application, service, or process, and uploads the generated framework within the running application, service, or process. Further, the hooking agent may also inject a small engine, such as a JavaScript engine, Python engine, or C++ engine, into the application space or control flow to execute the generated framework, as well as a just-in-time (JIT) compiler to support any probe code (e.g., C/C++, JavaScript, Python) used in the generated framework. Those skilled in the art will appreciate that although this specification mentioned the use of “Ptrace” as the injection mechanism in a given embodiment, different injection mechanisms may be employed. These injection mechanisms, which attach to an application, process, or service to inject an application server, can vary depending on the operating system or environment hosting the application, process, or service.

### Function Hooking and Execution Stage

At the third stage, the injected application server may start the probe sequence by first loading any module required for infiltration testing the environment or computer network. In some embodiments, the generated framework may specify a predefined user-setting that defines whether the probe sequence initiates upon the occurrence of an event, such as from a new network connection or file access. In these cases, the application server (or generated framework) injects a probe handler function (i.e., injected code or function hook) at the beginning and/or end of the corresponding process function of the target application, based upon the predefined user-setting. For example, if a probe sequence is to be triggered on a new connection to a web server (i.e., target application), as defined by the predefined user-setting, the application server (or generated framework) injects a handler at the end of the accept function in the standard C library (i.e., libc). New incoming connections to the web server trigger calls to the accept function of the web server, consequently initiating the probe sequence. In other embodiments, if a probe sequence is to be launched (e.g., initiated) at intervals (i.e., a time interval) or at a specific moment (i.e., time), as defined by the predefined user-setting, the application server (or generated framework) injects a thread in the application space or control flow of the target application, programmed to launch the probe sequence at the corresponding intervals or specific moment. Although the three stages described above were described in a specific order, it should be understood that other stages may be performed among the three stages or may be performed in an order other than that described, or stages may be adjusted so that they occur at slightly different times.

Illustrative embodiments also include launching simulated adversary attacks on a computer network. Such embodiments may also specify the initiation of a probe sequence based on a predefined user-setting.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

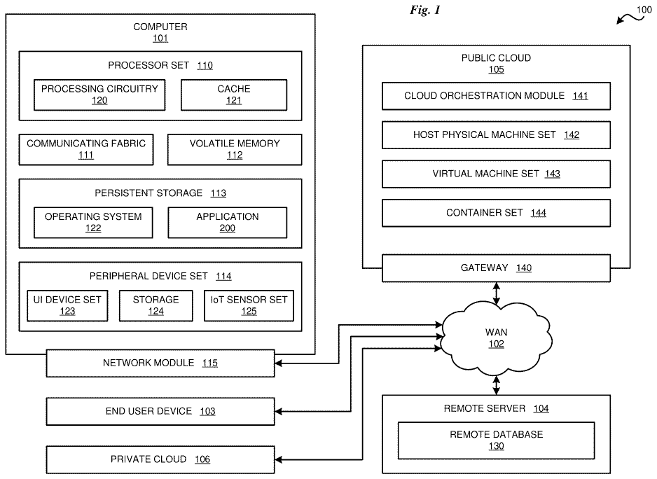

With reference to FIG. 1, this figure depicts a block diagram of a computing environment 100. Computing environment 100 contains an example of an environment for the execution of at least some computer code involved in performing the inventive methods, such as an example application 200 for launching simulated adversary attack process by identifying a first target application, running on a host computer, that is on a computer network. The following are definitions for terms used throughout the disclosure. “Probe sequence” is a term used in the present disclosure to describe as one or more computer code/ instructions/events/triggers occurring in a predetermined order/in any order so long as instructions/events/triggers occur or so long as at least a subset of them occur in some order; “Probe” is a term used in the present disclosure to describe as a tactic, technique, procedure (TTP) used to identify one or more security gaps in a host or network's posture from an application's perspective or a simulated attack or a simulated exploit including at least some source computer code; The term “probe” may be used interchangeably with the term “simulated attack” or “simulated exploit” in the present disclosure; “Framework” is a term used in the present disclosure to describe computer code or instructions or set of code objects, or payload, is embeddable into a target application's or program's address space; “Target application” is a term used in the present disclosure to describe a running computer program, application, or service, or legacy application on a host computer or set of host computers on a computer network; “Injected” is a term used in the present disclosure to describe simulated cyber-attack or simulated hacking technique that involves incorporating TTP related code into a computer program, application code, or control flow of computer program, application, or service; The term “injected” and various forms (e.g., injecting) may be used interchangeably with the terms “patched” or “attached” or “hooked” or “latched” or “incorporated” or “connected” or “embedded” and their various forms (e.g., patching) in the present disclosure; “Infiltration” is a term used in the present disclosure to describe various simulated cyber-attacks or simulated hacking techniques to identify security vulnerabilities or gaps in a computer network; The term “infiltration” may be used interchangeably with terms “system-penetration” or “network-penetration”; “Storyboard package” is a term used in the present disclosure to describe a library of tactics, techniques, and procedures (TTPs) including computer code that when the library and the library's TTPs are applied enables the identification of security gaps, from the perspective of a target application on which the library was injected, on a host computer, host computers, or surrounding computer networks or computers; “Instrumentation plan” is a term used in the present disclosure to describe an user intention or strategy for specifying which specific computer hosts, services, applications, and/or processes that a user intends to hook or latch to during one or more probes or simulated attacks or network-penetration tests, and how the user desires that the one or more probes or simulated attacks or network-penetration tests propagate or broadcast throughout a computer network; “Application flow” is a term used in the present disclosure to describe a thread of execution or the smallest sequence of computer instructions or computer code that can be managed independently by a scheduler or program execution (i.e., process of carrying out a program of the target application) or address space; The term “application flow” may be used interchangeably with terms “application code” or “control flow.”

In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

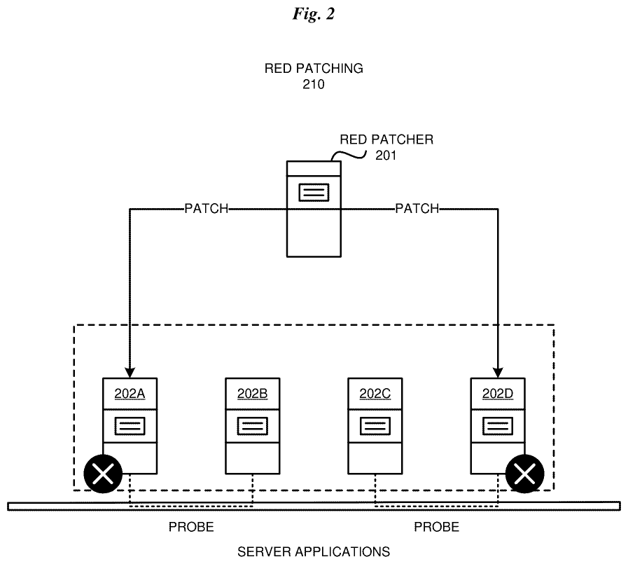

With reference to FIG. 2, this figure depicts a block diagram of an example red patching infrastructure 210 in accordance with an illustrative embodiment. In the illustrated embodiment, the red patching infrastructure 210 includes red patcher computer 201 (e.g., computer 101 and/or running application 200) and four computer servers 202a-202d (e.g., public clouds 105a-105d), running various server applications (e.g., network modules 115a-115d) not shown, respectively, in FIG. 1. In this example embodiment, red patcher computer 201 first identifies and then patches target computer servers 202a and 202d. In some embodiments, red patcher computer 201 allows a user to plan the goals and objectives of a probe or simulated exploit (i.e., a campaign) to explore the vulnerabilities of a computer network using the running target server application. A computer user interface (e.g., user interface (UI) device set 123), included in red patcher computer 201, designs probe sequences with modules, configurations, computer code and snippets, predefined TTPs, and probe kill chains. The computer user interface of red patcher computer 201 further includes a comprehensive framework and rich toolset, supporting coding probes and TTPs in various programming languages, such as JavaScript, and C/C++. In some embodiments, TTPs may be realized as code snippets that conduct some network-penetration testing behaviors and may be triggered by events coming into the target server application(s) (e.g., a network connection), or simply at intervals. In some embodiments, patching (e.g., injecting or attaching) may be accomplished by incorporating a framework into the application code, application flow, or control flow of a target server application. In some embodiments, the injection mechanism (e.g., patching mechanism) for incorporating the framework (i.e., generated framework) in the target application may be Ptrace. Those skilled in the art will appreciate that although this specification mentioned the use of “Ptrace” as the injection mechanism in a given embodiment, different injection mechanisms may be employed. These injection mechanisms, which attach to an application, process, or service to inject an application server, can vary depending on the operating system or environment hosting the application, process, or service.

As described earlier, Ptrace enables one application, service or process to control the execution of another application, service or process (i.e., target server application) by deployment of a hooking agent. Ptrace may use hot patching or dynamically updating a system, service, or application without downloading a new version of the system, service, or application when deploying the hooking agent. The hooking agent connects or hooks to the running application, service or process (i.e., target server application), creates a thread of operation within the application space, application flow, or control flow of the running application, service or process, and uploads the framework within the running server application, service or process. Once the framework is uploaded, for example in a “target server application A,” it can be determined what files that the “target server application A” has access to, what other computer hosts that the “target server application A” may contact or what other services that the “target server application A” may use. In some embodiments, the hooking agent injects a small engine (e.g., JavaScript engine, Python engine, or C++ engine) into the application space, application flow, or flow control to execute the framework, as well as a just-in-time (JIT) compiler to support any probe code (e.g., C/C++, JavaScript, Python) used in the framework. The injected application server may start the probe sequence by first loading any module or TTP required by the framework for simulating attacks on the vulnerabilities of the computer network by the target server application. In some embodiments, the framework may also specify a predefined user-setting that defines what event (e.g., file access or connection request) or condition (e.g., interval or time) that triggers a probe sequence using the target server application. Referring back to FIG. 2, now compromised (e.g., patched), computer server 202a, probes (based upon a predefined user-setting defining a probe sequence that initiates a probe) uncompromised (e.g., unpatched) computer server 202b. Similarly, compromised, computer server 202d probes uncompromised computer server 202c.

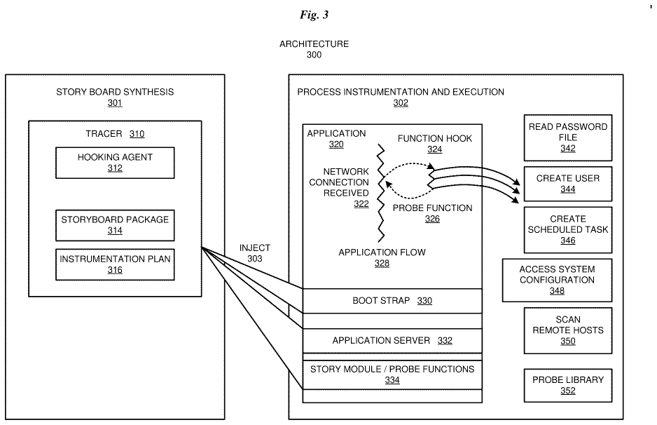

With reference to FIG. 3, this figure depicts a block diagram of an example architecture of 300 in accordance with an illustrative embodiment. In the illustrated embodiment, the example architecture 300 includes modules storyboard synthesis 301 and process instrumentation and execution 302. In some embodiments, storyboard synthesis 301 module facilitates goals planning and objectives setting for a simulated (e.g., emulated, or modeled) or production-based probe from a target application running on a computer network for network-penetration testing. In addition to providing a computer user interface (e.g., user interface (UI) device set 123) to design probe sequences, storyboard synthesis 301 further includes a tracer 310, which consists of a hooking agent 312, a storyboard package 314, and an instrumentation plan 316. The hooking agent 312 is deployed by an application, service, or process to control the execution of another application, service or process (e.g., a target application). The storyboard package 314 may include computer code having TTPs that enable identification of security gaps in a computer network under testing. The instrumentation plan 316 may outline the strategy for hooking or patching specific computer hosts, applications, services, and processes during network penetration testing. The instrumentation plan 316 also details how simulated attacks are propagated throughout the computer network during the testing process. For example, the instrumentation plan 316 may specify hooking “all network-facing applications” on target hosts X, Y, and Z. The corresponding simulated attacks are propagated by means of “all network-facing applications” on target hosts X, Y, and Z.

Referring back to FIG. 3, the output of storyboard synthesis 301 module (i.e., Storyboard Synthesis stage) is injected 303 into the application flow 328 (e.g., application code or control flow) of the application 320 (i.e., target application) illustrated within process instrumentation and execution 302 module (e.g., Process Instrumentation and Function Hooking and Execution stage). However, it should be appreciated that, before the injection 303 of the output of storyboard synthesis 301 module, the application flow 328 consisted of the original, unmodified computer code, including the instructions and logic necessary for the intended functionality of the application. After the injection 303 of the output from storyboard synthesis 301 module, the application flow 328 (e.g., application code or control flow) of the application 320 (i.e., target application) is modified (e.g., compromised). As illustrated, now, the application flow 328 of the application shown within process instrumentation and execution 302 module includes at least some instructions and logic necessary for the intended functionality of the application 320, including a network connection received 322, and also a function hook 324, a probe function 326, a bootstrap 330 (e.g., for loading the application server or function hook or instruction into a computer memory of the application's host computer), an application server 332, and story modules/probe functions 334 (i.e., new computer code or instructions). The function hook 324 (as well as the probe functions and story modules) may setup one or more of the following tactics, techniques or procedures (TTPs) to see if the application has access rights to do some of the following for example: reading a password file 342, creating a user 344, creating a scheduled task 346, scanning remote hosts 350, checking access to system configurations 348, or invoking any other storyboard/probe library function 352 or other simulated behavior(s). Those skilled in the art will appreciate that although this specification mentioned the use of one or more of the following tactics, techniques or procedures (TTPs) to see if the application has access rights to do some actions in a given embodiment, other actions are contemplated by the inventors.

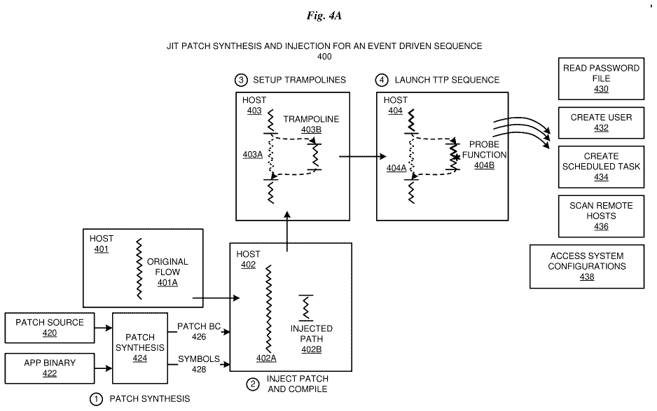

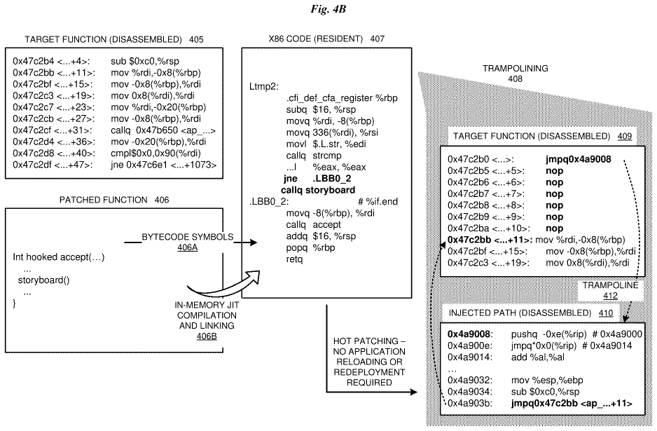

With reference to FIG. 4A, this figure depicts a block diagram of an example JIT (just-in-time) patch synthesis and injection for an event-driven sequence 400 in accordance with an illustrative embodiment. In this embodiment, the original flow 401A (e.g., application code) of the host 401 (e.g., a target application) is compromised and controlled to simulate network infiltration during the Storyboard Synthesis, Process Instrumentation, and Function Hooking and Execution stages described earlier. FIG. 4A further illustrates how a storyboard sequence (e.g., the execution of an instrumentation plan for one target application), during the Function Hooking and Execution stage, responds to a target application's application event like receiving a packet from the computer network (e.g., an event-driven sequence). In the illustrated embodiment, the JIT patch synthesis and injection for an event-driven sequence 400 is decomposed into four sub-stages: (1) patch synthesis, (2) inject path and compile, (3) setup trampolines, and (4) launch TTP sequence. At (1) patch synthesis sub-stage (above “(1) PATCH SYNTHESIS” 424 label), an uncompromised, host 401 (e.g., a target application) and the host's original flow 401A (e.g., application code), which consist of an unmodified program execution or process of carrying out a program of the target application, are depicted as box (labeled as “host”) with a vertical zig zag (labeled as “original flow”). The host's original flow 401A already includes a function or network-facing interface for receiving a packet from the network. Below the box labeled “host,” three additional boxes are depicted and labeled, respectively, “patch source,” “app binary,” “patch synthesis.” Patch source 420 (e.g., new computer code or a framework being injected to compromise the target application) and app binary 422 (e.g., the target application's binary code or computer code in executable form) are fed as inputs into the patch synthesis module 424 (e.g., an instance of the storyboard synthesis 301 module), which outputs patch bc 426 (i.e., patch bytecode) and symbols 428 (i.e., application code symbols). It should be noted that the patch synthesis module 424 is an instance Storyboard Synthesis Stage. Whereas the Storyboard Synthesis Stage is primarily focused on generating compromising computer code or instructions for a group of target applications, the patch synthesis module 424 is primarily responsible for compromising a single target application and generating computer instructions or code (e.g., a framework) for controlling or commandeering that single target application. At (2) inject patch and compile sub-stage (above “(2) INJECT PATCH AND COMPILE” label), the inputs, patch bc 426 and symbols 428, as well as host's original flow 401A, are received and an injected thread is established in the target application (i.e., Host 402) to create the injected path 402B (e.g., executable form of the patch bc and symbols). Still referring to (2) inject patch and compile sub-stage, the received inputs, patch bc 426 and symbols 428, are injected into the host's modified flow 402A (i.e., application code) and the host 402 is compiled by the injected thread. As a result of (2) inject patch and compile sub-stage, the host 402 is compromised, now containing a modified flow 402A illustrated as an elongated vertical zig zag line (including a function or network-facing interface for receiving a packet) and a smaller vertical zig zag line with top and bottom bars illustrating the injected path 402B (e.g., injected application code in executable form) of the patch bc 426 and symbols 428, within the box labeled “host” (i.e., Host 402). At (3) setup trampolines sub-stage (below “(3) SETUP TRAMPOLINES” label), a trampoline 403B (e.g., a small stub function containing computer jump instructions or operations) is generated and is responsible for moving the execution 403A of the host 403 (i.e., host's modified flow including a function or network-facing interface for receiving a packet) to the injected path 403B (e.g., injected application code including a least one probe function), upon the occurrence of an application event (e.g., receiving a packet). Note that probe sequences can also be launched from the injected thread (e.g., injected path 403B) at intervals (e.g., a predefined user-setting). At (4) launch TTP sequence sub-stage (below “(4) LAUNCH TTP SEQUENCE” label), the host 404 is illustrated containing the modified flow 404A, which includes a function or network-facing interface for receiving a packet, with a probe function 404B (e.g., injected application code), integrated into host's modified flow 404A by the trampoline 403B from (3) setup trampolines sub-stage. The probe function 404B, based on the an application event like receiving a packet from the computer network in the current example, may setup one or more of the following tactics, techniques or procedures (TTPs) to see if the application has access rights to do some of the following for example: reading a password file 430, creating a user 432, creating a scheduled task 434, scanning remote hosts 436, checking access to system configurations 438, or invoking any other storyboard/probe library function 334 or other simulated behavior(s). Those skilled in the art will appreciate that although this specification mentioned the use of one or more of the following tactics, techniques or procedures (TTPs) to see if the application has access rights to do some actions in a given embodiment, other actions are contemplated by the inventors. Although the four sub-stages described above were described in a specific order, it should be understood that other sub-stages may be performed among the four sub-stages or may be performed in an order other than that described, or sub-stages may be adjusted so that they occur at slightly different times.

With reference to FIG. 4B, this figure depicts a block diagram of an example JIT patch synthesis and injection 400 in accordance with an illustrative embodiment. In the illustrated embodiment, computer code/assembly examples target function (disassembled) 405, patched function 406 are associated with (1) patch synthesis sub-stage of FIG. 4A. Computer code/assembly example X86 code (resident) 407 (e.g., host or target application) is associated with (2) inject patch and compile stage of FIG. 4A. Computer code/assembly example trampolining 408, which includes target function (dissembled) 409, trampoline 412, and injected patch (dissembled) 410, is associated with sub-stages (3), (4) and (5) of FIG. 4A. Further, the example patched function 406 illustrates int hooked accept function including a storyboard function. The patched function 406 is hot patched, or in-memory JIT compiled and linked 406B into the X86 Code (resident) 407 (e.g., host or target application). It should be appreciated that the int hooked accept function (e.g., accept network connection function) is called whenever the target application (e.g., X86 code or host) receives a network connection from a computer network. As a result, when the target application receives a packet, a set of probe sequences are triggered, which may include the storyboard function. The example X86 code (resident) 407 illustrates the result of in-memory JIT compilation and linking 406B (e.g. hot patching) and bytecode symbols 406A transfer to embed (i.e., inject) functions: callq storyboard, callq accept functions, and jne function (e.g., a jump function or jump if equal). Those skilled in the art will appreciate that FIG. 4B shows an example of hot patching (e.g., dynamically updating a target application without downloading a new version of the target application), so it is not required that the target application's application code be reloaded or redeployed.

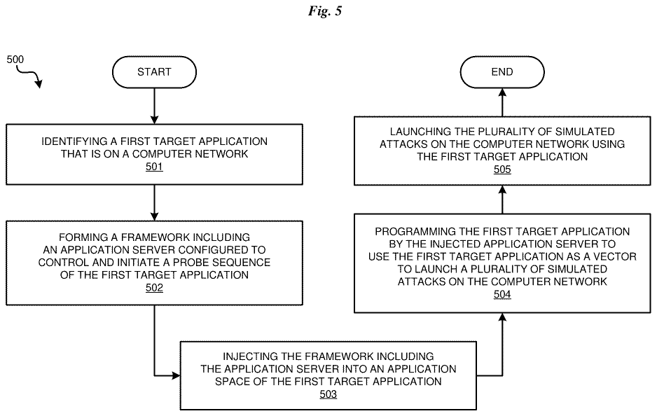

With reference to FIG. 5, this figure depicts a flowchart of an example process for launching simulated adversary attacks on a computer network in accordance with an illustrative embodiment. In the illustrated embodiment, the example process 500 includes method steps 501, 502, 503, 504, and 505. Step 501 begins the launching adversary attack simulation process by identifying a first target application that is on a computer network. Step 502 forms a framework including an application server configured to control and initiate a probe sequence of the first target application. Step 503 injects the framework including the application server into an application space or application code of the first target application. Next, step 504 programs (e.g., hot patching) the first target application by the injected application server to use the first target application as a vector to launch a plurality of stimulated attacks on the computer network. Finally, step 505 launches the plurality of stimulated attacks on the computer network using the first target application. In some embodiments, data may be collected on the computer network during the plurality of simulated attacks by the first target application on the computer network for use as a realistic attack scenario dataset. The realistic attack scenario dataset may be used to adjust or optimize generated frameworks or instrumentation plans. Although the five steps described above were described in a specific order, it should be understood that other steps may be performed among the five steps, or may be performed in an order other than that described, or steps may be adjusted so that they occur at slightly different times. Further, it should be understood that a plurality of target applications may be identified as identified in the given embodiment above, and for each target application in the plurality of target applications, the method steps of the given embodiment are executed, and the plurality of target applications may be used as a single probe vector or probe vectors to launch a plurality of simulated attacks on a computer network.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer implemented method for launching simulated adversary attacks on a computer network, the method comprising:
identifying a first target application that is operable on the computer network;
forming a framework including an application server configured to initiate a probe sequence by the first target application based a predefined user-setting;
injecting the framework including the application server into an application space of the first target application; and
programming the first target application by the injected application server, including specifying the probe sequence based on the predefined user-setting and to use the first target application as a vector to launch a plurality of simulated attacks on the computer network.

2. The method of claim 1, further comprises:
launching the plurality of simulated attacks on the computer network using the first target application.

3. The method of claim 2, further comprises:
identifying a second target application that is operable on the computer network;
forming a framework including an application server configured to control and to initiate a probe sequence by the second target application based a predefined user-setting;
injecting the framework including the application server into an application space of the second target application;
programming the second target application by the injected application server, including specifying the probe sequence based on the predefined user-setting and to use the second target application as a vector to launch a plurality of simulated attacks on the computer network; and
launching the plurality of simulated attacks on the computer network using the second target application.

4. The method of claim 3, further comprises:
coordinating the plurality of simulated attacks on the computer network using the first target application and the second target application.

5. The method of claim 1, wherein injecting the framework including the application server into an application space of the first target application, further comprises: employing Ptrace as the injection mechanism.

6. The method of claim 2, further comprising:
monitoring the data on the computer network; and
collecting data on the computer network during the plurality of simulated attacks by the first target application on the computer network for use as a realistic attack scenario dataset.

7. The method of claim 1, wherein the predefined user-setting comprises defining a probe sequence to initiate upon the occurrence of an event.

8. The method of claim 1, wherein the predefined user-setting comprises defining a probe sequence to initiate at a time interval or specific time.

9. The method of claim 2, wherein launching the plurality of simulated attacks on the network using the first target application includes deploying at least one script.

10. A computer usable program product comprising one or more computer readable storage media, and program instructions collectively stored on the one or more computer readable storage media, the program instructions executable by a processor to cause the processor to perform operations comprising:
identifying a first target application that is operable on the computer network;
forming a framework including an application server configured to initiate a probe sequence by the first target application based a predefined user-setting;
injecting the framework including the application server into an application space of the first target application; and
programming the first target application by the injected application server, including specifying the probe sequence based on the predefined user-setting and to use the first target application as a vector to launch a plurality of simulated attacks on the computer network.

11. The computer usable program product of claim 10, further comprises:
launching the plurality of attacks on the computer network using the first target application.

12. The computer usable program product of claim 11, further comprises:
identifying a second target application that is operable on the computer network;
forming a framework including an application server configured to control and to initiate a probe sequence of the second target application based a predefined user-setting;
injecting the framework including the application server into an application space of the second target application;
programming the second target application by the injected application server, including specifying the probe sequence based on the predefined user-setting and to use the second target application as a vector to launch a plurality of simulated attacks on the computer network; and
launching the plurality of simulated attacks on the computer network using the second target application.

13. The computer usable program product of claim 12, further comprises:
coordinating the plurality of simulated attacks on the computer network using the first target application and the second target application.

14. The computer usable program product of claim 10, wherein injecting the framework including the application server into an application space of the first target application, further comprises: employing Ptrace as the injection mechanism.

15. The computer usable program product of claim 11, further comprising:
monitoring the data on the computer network; and
collecting data on the computer network during the plurality of simulated attacks by the first target application on the computer network for use as a realistic attack scenario dataset.

16. The computer usable program product of claim 10, wherein the predefined user-setting comprises defining a probe sequence to initiate upon the occurrence of an event.

17. A computer system comprising a processor and one or more computer readable storage media, and program instructions collectively stored on the one or more computer readable storage media, the program instructions executable by the processor to cause the processor to perform operations comprising:
identifying a first target application that is operable on the computer network;
forming a framework including an application server configured to initiate a probe sequence by the first target application based a predefined user-setting;
injecting the framework including the application server into an application space of the first target application; and
programming the first target application by the injected application server, including specifying the probe sequence based on the predefined user-setting and to use the first target application as a vector to launch a plurality of simulated attacks on the computer network.

18. The computer system of claim 17, further comprises:
launching the plurality of simulated attacks on the computer network using the first target application.

19. The computer system of claim 18, further comprises:
identifying a second target application that is operable on the computer network;
forming a framework including an application server configured to control and to initiate a probe sequence of the second target application based a predefined user-setting;
injecting the framework including the application server into an application space of the second target application;
programming the second target application by the injected application server, including specifying the probe sequence based on the predefined user-setting and to use the second target application as a vector to launch a plurality of simulated attacks on the computer network; and
launching the plurality of simulated attacks on the computer network using the second target application.

20. The computer system of claim 19, further comprises:
coordinating the plurality of simulated attacks on the computer network using the first target application and the second target application.
